(19) United States
(12) Patent Application Publication
(10) Pub. No.: US 2001/0021005 A1
(43) Pub. Date: Sep. 13, 2001

(54) Projection apparatus and three-dimensional image display apparatus

(76) Inventors: Manami Kuiseko, Kyoto-shi (JP); Ken Yoshii, Itami-shi (JP); Makoto Miyazaki, Ibaraki-shi (JP)

Correspondence Address: SIDLEY AUSTIN BROWN & WOOD, 717 NORTH HARWOOD, SUITE 3400, DALLAS, TX, 75201, US

(21) Appl. No.: 09/770,426

(22) Filed: Jan. 26, 2001

(30) Foreign Application Priority Data
Jan. 26, 2000 (JP) P2000-017162

(51) Int. Cl. G03B 21/00

(52) U.S. Cl. 353/33

(57) ABSTRACT

A projection apparatus and a three-dimensional image display apparatus are provided. Light being separated into R, G and B color components reflected from a digital micromirror device through a TIR prism is directed into a both side telecentric optical system, is image-formed in the both side telecentric optical system, and is then directed into a processing optical system including optical path length compensators, dichroic mirrors, mirrors and an image rotation compensating mechanism without being vignetted The both side telecentric optical system is designed to satisfy |f1|>75 mm where f1 is the focal length of the entire both side telecentric optical system. The both side telecentric optical system has a long back focal length to allow the processing optical system to be easily placed in front of a projection optical system. Thus, the projection apparatus and the three-dimensional image display apparatus facilitate the insertion of the processing optical system therein.

This application is based on application No. 2000-17162 filed in Japan, the contents of which ate hereby incorporated by reference.

### BACKGROUND OF THE INVENTION

1. Field of the Invention

The present invention relates to a projection apparatus for displaying images by projection, and a three-dimensional (3-D) image display apparatus.

2. Description of the Background Art

Projection apparatuses such as projectors which display desired images by projection on a screen and the like are conventionally known. For example, a reflective projection apparatus comprises a light source, a reflective display device, and a projection optical system. While an image is displayed on the display device based on digital image data, light from the light source is directed onto the display device, and the light reflected from the display device is projected onto a projection target such as a screen by the projection optical system to display an image on the projection target.

The projection apparatus as above described, however, is sometimes required to process images. For example, a need to invert an image before projection requires an image inversion optical system to be provided between the display device and the projection optical system. Thus, in some projection apparatuses of the above-mentioned type, an optical system (referred to hereinafter as a processing optical system) for performing various types of processing, e.g. the above-mentioned processing such as image inversion, upon the image reflected from the display device is provided between the display device and the projection optical system, in which case some of the rays of light reflected from the display device are obstructed, or vignetted, in the optical system because of their different directions of reflection. It has been very difficult for optical design to-prevent such vignetting.

### SUMMARY OF THE INVENTION

The present invention is intended or a projection apparatus.

According to a first aspect of the present invention, the projection apparatus comprises: a display device for displaying an image to be projected; a both side telecentric optical system for image-forming the image displayed on the display device as an intermediate image on an intermediate image plane; and a projection optical system for projecting the intermediate image formed on the intermediate image plane onto a final image plane.

The projection apparatus can properly project the image onto the final image plane since light from the display device is not vignetted.

According to a second aspect of the present invention, in the projection apparatus of the first aspect, the both side telecentric optical system has a magnification of 1X.

According to a third aspect of the present invention, in the projection apparatus of the first aspect the both side telecentric optical system comprises, in order from a side of the display device: a first-group lens system; a diaphragm; and a second-group lens system. The first-group lens system and the second-group lens system are in symmetric mirror-image relation to each other with respect to the diaphragm.

The projection apparatus according to the third aspect of the present invention allows another optical system to be placed in the optical path without vignetting of the light from the display device.

According to a fourth aspect of the present invention, in the projection apparatus of the third aspect, the first-group lens system comprises, in order from the side of the display device: at least one first-group positive lens element; a first-group cemented lens including at least one positive lens element and at least one negative lens element; and at least one first-group negative lens element. The second-group lens system comprises, in order from the side of the display device: at least one second-group negative lens element; a second-group cemented lens including at least one negative lens element and at least one positive lens element; and at least one second-group positive lens element.

According to a fifth aspect of the present invention, in the projection apparatus of the fourth aspect, the at least one positive lens element and the at least one negative lens element in each of the first-group cemented lens and the second-group cemented lens are a single positive lens element and a single negative lens element, respectively. The first-group lens system further comprises a first-group lens element between the first-group cemented lens and the first-group negative lens element. The second-group lens system further comprises a second-group lens element between the second-group cemented lens and the second-group negative lens element Each of the first-group negative lens element and the second-group negative lens element is disposed, with its surface of a steeper curvature oriented toward the diaphragm.

According to a sixth aspect of the present invention, in the projection apparatus of the fourth aspect, the at least one first-group positive lens element includes two first-group positive lens elements. The at least one positive lens element and the at least one negative lens element in the first-group cemented lens are a single positive lens element and a single negative lens element, respectively. The at least one first-group cemented lens further comprises another lens element The at least one first-group negative lens element is disposed, with its surface of a steeper curvature oriented toward the diaphragm. The at least one second-group positive lens element includes two second-group positive lens elements. The at least one positive lens element and the at least one negative lens element in the second-group cemented lens are a single positive lens element and a single negative lens element, reactively. The second-group cemented lens further comprises another lens element. The at least one second-group negative lens element is disposed, with its surface of a steeper curvature oriented toward the diaphragm

According to a seventh aspect of the present invention, in the projection apparatus of the fourth aspect, the at least one first-group positive lens element includes two first-group positive lens elements. The at least one positive lens element and the at least one negative lens element in the first-group cemented lens are a single positive lens element and a single negative lens element, respectively. The at least one first-group negative lens element is disposed, with its surface of a steeper curvature oriented toward the diaphragm The at least one second-group positive lens element includes two second-group positive lens elements The at least one positive lens clement and the at least one negative lens element in the second-group cemented lens are a single positive lens element and a single negative lens element, respectively. The at least one second-group negative lens element is disposed, with its surface of a steeper curvature oriented toward the diaphragm.

The projection apparatus according to the fourth to seventh aspects can contain the telecentric optical system having a long back focal length to project the image in an optimum condition onto the final image plane without vignetting of the light from the display device.

The present invention is also intended for a three dimensional image display apparatus.

According to the present invention, the three-dimensional image display apparatus comprises: a screen driven to rotate about an axis of rotation included in a projection surface thereof; and a projection apparatus for projecting an image onto the screen, the projection apparatus comprising: a display device for displaying the image; a both side telecentric optical system for image-forming the image displayed on the display device as an intermediate image on an intermediate image plane; and a projection optical system for projecting the intermediate image formed on the intermediate image plane onto a final image plane.

The three-dimensional image display apparatus according to the present invention can properly project the image onto the surface of the screen to achieve optimum display of a three-dimensional image since light from the display device is not vignetted.

It is therefore an object of the present invention to provide a projection apparatus and a three-dimensional image display apparatus which can facilitate the insertion of an additional processing optical system therein without vignetting of light from a display device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a 3-D image display apparatus according to the present invention;

FIG. 2 shows a construction of the 3-D image display apparatus including an optical system;

FIG. 3 is a schematic perspective view of a screen and a rotating member;

FIG. 4 shows the size of a cross-section image to be projected on the screen;

FIG. 5 shows an arrangement of a color filter according to the present invention;

FIG. 6 is a schematic view of an image generation surface of a DMD;

FIG. 7 is a detailed view of an intermediate optical system shown in FIG. 2;

FIG. 8 shows an optical path Of a both side telecentric optical system according to Example 1;

FIGS. 9A, 9B and 9C show aberrations of the both side telecentric optical system according to Example 1;

FIG. 10 shows an optical path of a both side telecentric optical system according to Example 2;

FIGS. 11A, 11B and 11C show aberrations of the both side telecentric optical system according to Example 2;

FIG. 12 shows an optical path of a both side telecentric optical system according to Example 3;

FIGS. 13A, 13B and 13C show aberrations of the both side telecentric optical system according to Example 3;

FIG. 14 shows an optical path of a both side telecentric optical system according to Example 4;

FIGS. 15A, 15B and 15C show aberrations of the both side telecentric optical system according to Example 4;

FIG. 16 shows an optical path of a both side telecentric optical system according to Example 5;

FIGS. 17A, 17B and 17C show aberrations of the both side telecentric optical system according to Example 5;

FIG. 18 shows an optical path of a both side telecentric optical system according to Example 6; and

FIGS. 19A, 19B and 19C show aberrations of the both side telecentric optical system according to Example 6.

### DESCRIPTION OF THE PREFERRED EMBODIMENTS

Preferred embodiments according to the present invention will now be described with reference to the drawings.

<A. 3-D Image Display Apparatus>

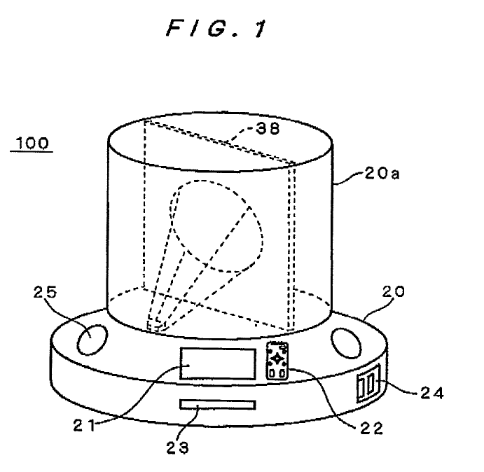

A 3-D image display apparatus 100 according to the present invention will now be described. FIG. 1 is a schematic view of the 3-D image display apparatus 100. The 3-D image display apparatus 100 comprises a housing 20 containing therein an optical system for projecting cross-section images onto a screen 38 and a control mechanism for various data processing, and a cylindrical windshield 20a mounted on the housing 20 for accommodating the screen 38 which rotates.

The windshield 20a is made of a transparent material such as glass and acrylic resin to allow an external observer to view the cross-section images projected on the screen 39 rotating therein. The windshield 20a provides a hermetical seal to define enclosed interior space, thereby stabilizing the rotation of the screen 38 and reducing the power consumption of a motor for driving the screen 38 for rotation.

A liquid crystal display (LCD) 21, a detachable control switch 22, and a slot 23 for receiving a recording medium 4 are disposed on the front surface of the housing 20. A digital input/output terminal 24 is provided on the side surface of the housing 20. The liquid crystal display 21 is used as a means for displaying an operating guide screen for operator's manual input and as a means for displaying a 2-D image of an object to be displayed. The digital input/output terminal 24 is a SCSI terminal, an IEEE 1394 terminal or the like. Four loudspeakers 25 for audio output are disposed on the outer peripheral surface of the housing 20.

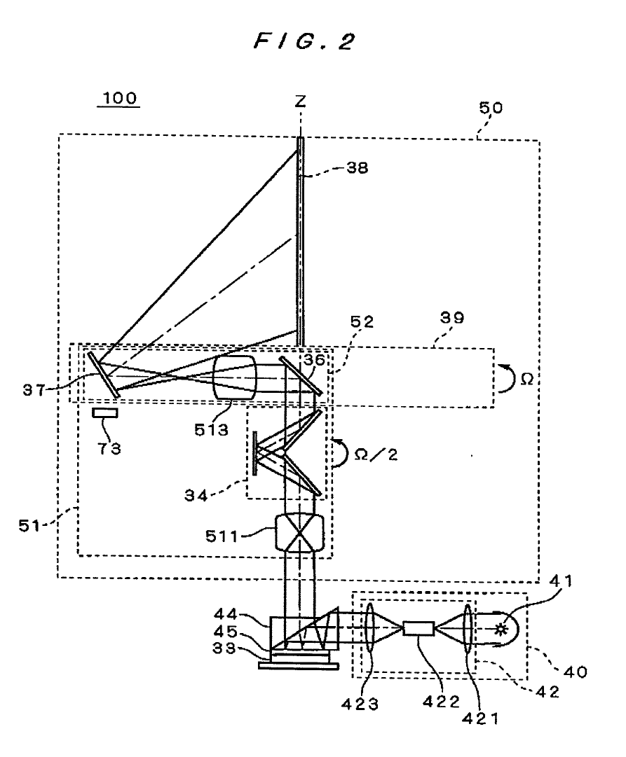

The optical system of the 3-D image display apparatus 100 for projecting the cross-section images onto the screen 38 is discussed below. FIG. 2 shows a construction of the 3-D image display apparatus 100 including the optical system. As illustrated in FIG. 2, the optical system of the apparatus 100 comprises an illumination optical system 40, an image projection optical system 50, a digital micromirror device (referred to hereinafter as a DMD which is a trademark of Texas Instruments Incorporated) 33, a TIR prism 44, a cover glass (not shown), and a color filter 45. The cover glass covers a surface of the TIR prism 44 which contacts the color filter 45, and is shown only in the figures depicting Examples of the present invention to be described later.

The DMD 33 is described first. The DMD 33 is a display device which displays an image to be projected, and is a reflective device which displays the image to thereby reflect the light toward the screen 38. The DMD 33 and the color filter 45 function as an image generating means for generating the cross-section images to be projected onto the screen 38. The DMD 33 includes a two-dimensional array of hundreds of thousands of minute mirrors (micromirrors) arranged closely on one chip, each of the mirrors being a rectangular metal piece (e.g. a piece of aluminum) which is about 16 μm in side length and serving as a pixel. The DMD 33 is capable of controlling the angle of inclination of the individual mirrors to ±10° by the action of the electrostatic field of an output from an SRAM disposed immediately under each pixel. The mirror angle control is ON/OFF binary control in response to the SRAM output “1”/“0. ” Specifically, when light from a light source impinges upon the mirrors, light reflected from a mirror positioned at the angle corresponding to the ON (or OFF) state travels toward the image projection optical system 50 whereas light reflected from a mirror positioned at the angle corresponding to the OFF (or ON) state deviates from an effective optical path and does not travel toward the image projection optical system 50. A cross-section image corresponding to an ON/OFF mirror distribution is generated by such ON/OFF control of the mirrors and projected onto the screen 38.

The DMD 33, which controls the angle of inclination of each mirror to change the direction in which light is reflected, can adjust the time required for this direction change (the length of reflection time) to represent the shades of gray (brightness level) of each pixel, specifically 256 brightness levels for one color.

Such a DMD 33 has two major features: an extremely highly efficient use of light and fast response, and is generally used in such applications as a video projector by making the most of its highly efficient use of light.

According to the present invention, the fast response which is the other feature of the DMD 33 is utilized to display not only a still image but also a moving image of the object, based on the volume scanning method utilizing the persistence of vision.

The DMD 33 requires 1 msec or less to generate a single image and therefore is very fast in operation since the deflection response time of each mirror thereof is about 10 μ sec and the image data is written thereinto in substantially the same manner as into a typical SRAM. If the time required to generate a single image is 1 msec, the DMD 33 can generate about 60 cross-section images when the rotation of the screen 38 through 180° requires 1/18 second (i.e., nine turns per second) for production of the persistence of vision. The DMD 33 is capable of projecting much more cross-section images onto the screen 38 per unit time than are the CRT and LCD used as the image generating means in the conventional volume scanning method, and achieving not only the 3-D representation of a rotational non-symmetric object but also the representation of a moving image.

The highly efficient use of light which is one of the features of the DMD 33 provides a brighter cross-section image to be projected onto the screen 38, contributing to the enhancement of the persistence of vision. Thus, the DMD 33 is capable of displaying a 3-D image having a higher quality than is the CRT or the like.

The color filter 45 divided into a plurality of regions corresponding to the respective color components is provided on the image generating surface side of the DMD 33, as shown in FIG. 2. The DMD 33 generates cross-section images (to-be-projected images or projectable images) for the color components in association with the regions, respectively. The TIR prism 44 is also provided on the image generating surface side of the DMD 33 to introduce illuminating light from the illumination optical system 40 through the color filter 45 onto the micromirrors and to introduce the cross-section images for the respective color components which are generated by the DMD 33 into the image projection optical system 50.

The illumination optical system 40 has a white light source 41 and an illumination lens system 42. The illumination lens system 42 converts the illuminating light from the white light source, 41 into collimated light The illumination lens system 42 includes a condenser lens 421, an integrator 422, and a relay lens 423. The illuminating light emitted from the white light source 41 is focused through the condenser lens 421 to enter the integrator 422. The integrator 422 renders uniform a light amount distribution of the illuminating light. The relay lens 423 collimates the light from the integrator 422. The collimated light from the relay lens 423 is directed into the TIR prism 44, passes through the color filter 45, and then impinges on the DMD 33.

The DMD 33 changes the angle of inclination of the individual micromirrors based on 2-D image data about a cross-section image provided from a host computer not shown or the like to reflect toward the image projection optical system 50 only light components of the illuminating light which are required for projection of the cross-section image.

The image projection optical system 50 has an image projection lens system 51 and the screen 38. The image projection lens system 51 includes an intermediate optical system 511, a projection lens 513, projection mirrors 36, 37, and an image rotation compensating mechanism 34. The projection lens 513 and the projection mirrors 36, 37 constitute a projection optical system 52, and are disposed inside a rotating member 39 for rotating the screen 38 about an axis of rotation Z.

The light (or cross-section image) reflected from the DMD 33 is collimated by the intermediate optical system 511. The collimated light passes through the image rotation compensating mechanism 34 for compensation for the rotation of the cross-section image. The light beam compensated for rotation by the image rotation compensating mechanism 34 is directed via the projection mirror 36, the projection lens 513 and the projection mirror 37 and finally projected onto a main surface (projection surface) of the screen 38. Thus, the image projection optical system 50 and the DMD 33 constitute a to-be-projected image generation means for sequentially generating the plurality of cross-section images based on the 2-D image data to sequentially project the plurality of cross-section images onto the screen 38 in synchronism with the rotation of the screen 38.

The projection mirror 36, the projection lens 513, the projection mirror 37 and the screen 38 in this optical system are fixed to the rotating member 39, and are rotated at an angular velocity Ω about the vertical axis of rotation Z including the central axis of the screen 38 as the rotating member 39 rotates. Since the projection mirror 36, the projection lens 513 and the projection mirror 37 which are disposed inside the rotating member 39 also rotate in conjunction with the screen 38 rotated for volume scanning, this optical system can always project the cross-section images onto the front surface of the screen 38 independently of the angular positions of the screen 38.

A position detector 73 constantly detects the angular position of the screen 38.

The cross-section image thus generated by the DMD 33 is projected onto the screen 38. The projection lens 513 functions to provide a suitable image size when the light beam comes onto the screen 38. The projection mirror 37 is positioned to project the cross-section image obliquely upwardly (from the inside of the rotating member 39 in FIG. 2) toward the front surface of the screen 38 so as not to obstruct the vision of an observer that views the 3-D image projected on the screen 38. The positional relationship between the projection lens 513 and the projection mirrors 36 and 37 is not limited to that described herein.

The image rotation compensating mechanism 34 is described below. The image rotation compensating mechanism 34 shown in FIG. 2 includes an arrangement known as an image rotator. A cross-section image projected on the screen 38 mounted on the rotating member 39 which is in a given angular position is used as a reference image. Without the use of the image rotation compensating mechanism 34, the cross-section images projected successively as the rotating member 39 rotates would rotate in the plane of the screen 38 so that a cross-section image is in inverted relationship with the reference image when the rotating member 39 is in the 180° angular position. The image rotation compensating mechanism 34 is provided to prevent such a phenomenon.

The image rotation compensating mechanism 34 shown in FIG. 2 employs the image rotator having a combination of mirrors. The image rotator has the property of providing an output image rotating at an angular velocity twice greater than the angular velocity of the image rotator rotated about the optical axis. Therefore, the image rotator may be rotated at an angular velocity one-half that of the rotating member 39 on which the screen 38 is mounted, permitting erect cross-section images to be always projected on the screen 38 independently of the rotation of the screen 38.

The image rotation compensating mechanism 34 is not limited to the image rotator but may employ a Dove prism which provides similar effects. Alternatively, the 3-D image display apparatus 100 need not employ the above-mentioned image rotation compensating mechanism 34 but may generate on the DMD 33 cross-section images rotating about the optical axis in accordance with the angular positions of the screen 38, thereby canceling the rotation of the projected images.

Specifically, the 2-D image data for generation of the cross-section images in the stage prior to the input to the DMD 33 may be corrected so that the cross-section image generated on the DMD 33 is an erect image (or an inverted image) at the start of the volume scanning and is an inverted image (or an erect image) at the end of the volume scanning after the rotation of the cross-section images in conjunction with the rotation of the screen 38.

FIG. 3 is a schematic perspective view of the screen 38 and the rotating member 39. As illustrated in FIG. 3, the rotating member 39 is disk-shaped, and is driven for rotation by a motor 74 serving as a rotatable drive means and having a rotary shaft in contact with the side surface thereof. Alternatively, the rotating member 39 may be driven by a motor directly coupled to the central shaft thereof or through gearing and a belt.

With reference to FIG. 3, when the screen 38 is in an angular position θ1, a cross-section image P1 (generated by the DMD 33) of the object which corresponds to the angular position θ1 is projected via the projection mirror 36, the projection lens 513 and the projection mirror 37 shown in FIG. 2 onto the screen 38. A little time later, when the screen 38 is rotated to an angular position θ2, a cross-section image ,P2 (generated by the DMD 33) of the object which corresponds to the angular position θ2 is projected via the projection mirror 36, the projection lens 513 and the projection mirror 37 shown in FIG. 2 onto the screen 38.

Since the projection mirror 36, the projection lens 513 and the projection mirror 37 held in predetermined positional relationship with the screen 38 rotate together therewith, the cross-section images are always projected on the screen 38 independently of the rotation. When the rotating member 39 is rotated 180° (or 360°), the same cross-section image as the initial one appears. This completes one volume scanning cycle. The above-described operation is performed so that the rotating member 39 is rotated at a speed high enough to create the persistence of vision and a sufficient number of cross-section images are projected onto the screen 38, allowing the observer to visually recognize the envelope of the cross-section images as a 3-D image of the object.

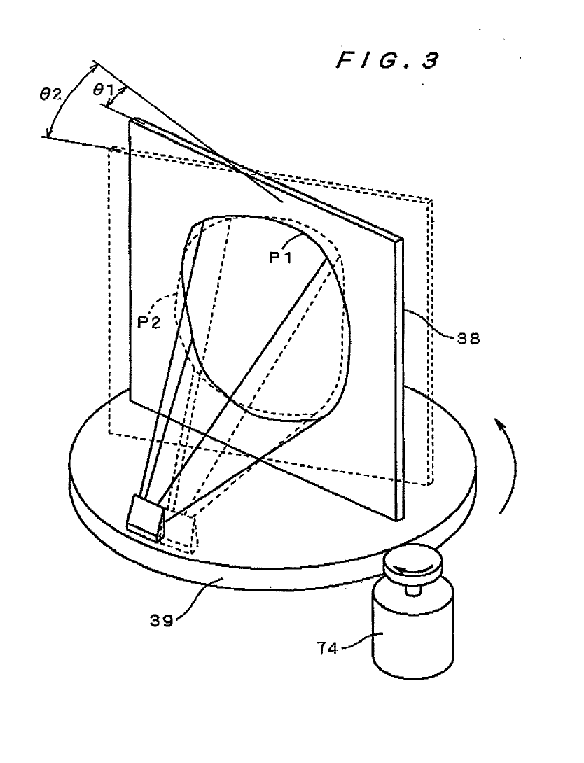

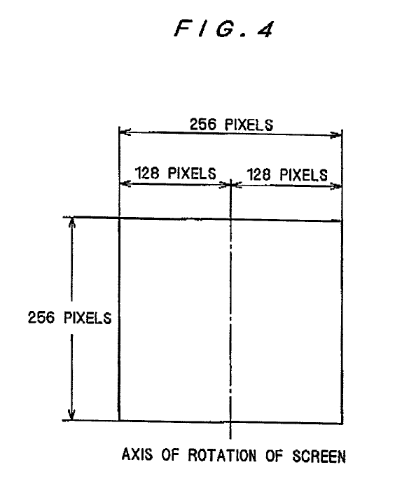

The size (resolution) of the cross-section images is described below. FIG. 4 shows the size of a cross-section image projected on the screen 38. The cross-section image is sized to contain a matrix of pixels with 256 rows and 256 columns and is symmetric with respect to the axis of rotation of the screen 38 when it is projected on the screen 38. In other words, the size of the cross-section image is such that each row of the matrix has 128 left-hand pixels and 128 right-hand pixels which are arranged outwardly from the axis of rotation. The projected cross-section images, which rotate in constant relationship with the screen 38 together, are constant in size independently of the rotation of the screen 38. It should be noted that the size of the cross-section image of FIG. 4 is shown only as a typical example, and the cross-section image may be of any size depending on the number of micromirrors of the DMD 33 to be used.

<B. Arrangement for Displaying Image in Color>

Description is given hereinafter on an arrangement for displaying an image in color according to the present invention. The color filter 45 is divided into the plurality of regions so that each of the regions allows one of the three color components R (red), G (green) and B (blue) of light to pass therethrough, for example. The cross-section images are displayed in color onto the screen 38 by dividing the color filter 45 into the regions respectively for the tree color components R, G and B.

The technique for displaying an image in color includes a conventional method of time-dividing the illuminating light directed into the DMD into the R, G and B components, and a method using three DMDs to generate cross-section images corresponding to the R, G and B components, respectively. The former, however, results in threefold increase in display time since one color cross-section image is generated by projecting three cross-section images for R, G and B. The latter which requires the three DMDs is unfavorable because of increased costs.

According to the present invention, the single DMD 33 is divided into the plurality of regions corresponding to R, G and B to reduce the time required to project one color image onto the screen 38 and to achieve multi-color image display at low costs.

FIG. 5 shows an arrangement of the color filter 45 according to the present invention. The color filter 45 as shown in FIG. 5 is used according to the present invention The color filter 45 shown in FIG. 5 is divided into three regions: a filter part 45a for transmitting the R light component, a filter part 45b for transmitting the G light component, and a filter part 45c for transmitting the B light component. Thus dividing the color filter 45 into the regions equal in number to the color components is easily practical at low costs. The color filter 45 divided into the regions as shown in FIG. 5 is placed on the image generating surface side of the DMD 33.

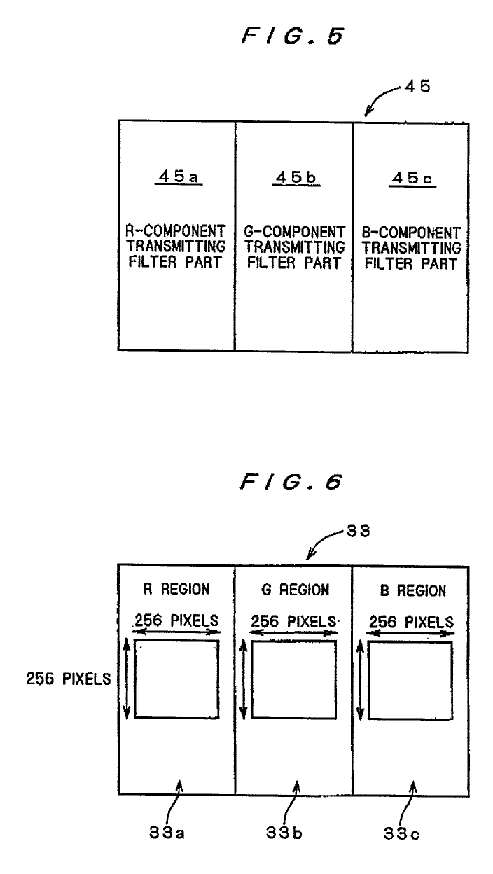

FIG. 6 schematically shows the image generating spice of the DMD 33. The color filter 45 as shown in FIG. 5 is placed on the DMD 33 to divide the image generating surface of the DMD 33 into three regions 33a, 33b, 33c. The regions 33a, 33b, 33c receive the R, G, B light components, respectively, through the color filter 45. In other words, this arrangement does not specify a color component for each pixel but specifies the regions for the respective color components, each of the regions being made up of a two-dimensional array of successive pixels, as shown in FIG. 6.

For projection of a cross-section image containing a 256 by 256 matrix of pixels on the screen 38 as shown in FIG. 4, each of the regions 33a, 33b, 33c of the DMD 33 has a 256- by 256-pixel image generating part located substantially in the center thereof for generating the cross-section image for its corresponding color component, as shown in FIG. 6. The use of the DMD 33 including a greater number of pixels (micromirrors) provides a sufficiently large spacing between the image generating parts of the regions 33a and 33b and between the image generating parts of the regions 33b and 33c, facilitating the mounting of the color filter 45 on the DMD 33. Arranging the image generating parts of the respective regions 33a to 33c in non-contacting relationship with each other prevents such a problem that the image generating parts receive other color light components due to a slight deviation of the mounting position of the color filter 45. Thus, the cross-section images corresponding to the respective color components are generated without problems.

In other words, the image generating means including the DMD 33 and the color filter 45 according to the present invention has the integrated pixel arrangement surface divided into the plurality of regions each specified as a two-dimensional array of successive pixels. These regions simultaneously generate the plurality of cross-section images corresponding to the different color components, respectively, which are required to project a 3-D image in multi-color onto the screen 38. Therefore, the image generating means of simple construction can display a 3-D image in color relatively easily at low costs. Additionally, if the color components are three components R, G and B, the arrangement according to the present invention can project the cross-section images the number of which is three times greater than the number of cross-section images used for displaying a color image by means of the time division technique, contributing to the increase in definition of the 3-D multi-color image to be projected onto the screen 38. Further, although displaying the color image by means of the time division technique requires a driver for rotating the rotary color filter, the arrangement according to the present invention in which the DMD 33 is divided into the plurality of regions which simultaneously generate the cross-section images corresponding to the color components, respectively, eliminates the need to provide a special driver for displaying the multi-color image. This reduces the size of the structure for displaying the multi-color image.

<C. Intermediate Optical System>

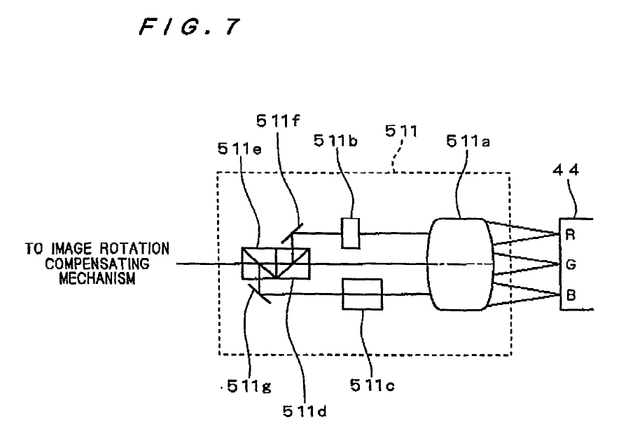

The intermediate optical system 511 is described below. FIG. 7 is a detailed view of the intermediate optical system 511 shown in FIG. 2. The above described generation of the cross-section images corresponding to the components R, G and B respectively in the different regions requires the cross-section images to be combined together into one image in the course of projecting the cross-section images onto the screen 38. This forms one multi-color image.

The intermediate optical system 511 comprises a both side telecentric optical system 511a, optical path length compensators 511b, 511c, dichroic mirrors 511d, 511e, and mirrors 511f, 511g. The intermediate optical system 511 combines the cross-section images corresponding to the color components generated respectively in the regions 33a to 33c of FIG. 6 together into one optical path.

The R, G and B light components (cross-section images) generated in the respective regions of the DMD 33 pass through the TIR prism 44 and are collimated by the both side telecentric optical system 511a. The collimated R, G and B light components (cross-section images) from three different optical paths, respectively. For instance, as illustrated in FIG. 7, the three collimated light beams are such tat the R light component passes above the G light component and the B light component passes below the G light component.

The R light component collimated by the both side telecentric optical system 511a is directed into the optical path length compensator 511b for compensating for the difference in optical path length between the R component cross-section image and the G component cross-section image. The R light component compensated for the optical path length difference is totally reflected firm the mirror 511f and then combined with the G light component by the dichroic mirror 511d. The dichroic mirror 511d reflects the R light component and transmits other light components. Thus, the dichroic mirror 511d reflect the R light component and transmits the G light component to combine the R and G light components together into one optical path.

The B light component collimated by the both side telecentric optical system 511a is directed into the optical path length compensator 511c for compensating for the difference in optical path length between the B component cross-section image and the G component cross-section image. The B light component compensated for the optical path length difference is totally reflected from the mirror 511gand then combined with the R and G light components by the dichroic mirror 511e. The dichroic mirror 511e reflects the B light component and transmits other light components. Thus, the dichroic mirror 511e reflects the B light component and transmits the R and G light components to combine the R, G and B light components together into one optical path.

The combined R, G and B light components are projected via the image rotation compensating mechanism 34, the projection mirror 36, the projection lens 513 and the projection mirror 37 onto the screen 38, as shown in FIG. 2.

Thus, the cross-section images corresponding to the R, G and B light components generated in the different regions of the DMD 33 may be combined into the single image in the course of projecting the cross-section images onto the screen 38. Therefore, one proper color cross-section image is projected onto the screen 38.

The optical path length compensators 511b and 511c disposed in the optical paths of the R and B light components are made of media having predetermined refractive indices, respectively. The passage of the light components through the media enables the optical path length compensators 511b and 511c to compensate for the optical path length difference based on the refractive indices of the media and the thicknesses of the media along the optical axis.

A cross-section image generated by combining the color components together into one optical path is contemplated, with reference to FIG. 7. Since the G light component has a shorter optical path than the R and B light components, the G light component forms an image in a position farther forward along the optical axis than the positions in which the R and B light components form images. That is, the difference in optical path length between the color components results in the difference in image-forming position therebetween, Without any compensation, one of the color components would form a cross-section image on the projection surface of the screen 38 but other color components would not. This results in the presence of a blurred image among the cross-section images corresponding to the color components projected on the screen 38, decreasing the quality of the displayed image.

To solve such a problem, the optical path length compensators 511b and 511c are disposed in the optical paths of the R and B components to compensate for the differences in optical path length between the R and G components and between the B and G components, thereby causing the image-forming positions of the R and B components to coincide with the image-forming position of the G component. This enables the R, G and B light components to form the cross-section images at the same position on the projection surface of the screen 38, presenting sharp cross-section images of high quality.

<D. Both side Telecentric Optical System>

As above discussed, the intermediate optical system 511 according to the present invention comprises the both side telecentric optical system 511a serving as a 1X magnification image-forming optical system. The reason why this optical system is both side telecentric is to be described below.

On the display device (DMD 33) side (or the object side in a magnifying optical system), the optical system is required to have telecentricity (object-side telecentricity) so as to prevent the light reflected from the DMD 33 from being obstructed, or vignetted, by an optical system (referred to hereinafter as a “processing optical system”) for performing various types of processing upon the reflected light.

On the intermediate image forming side (or the image side in the magnifying optical system), the optical system is desired to have telecentricity (image-side telecentricity) so as to relay the light to the projection optical system 52 without losses of the amount of light and to eliminate the need to provide a condenser lens when the light impinges upon the projection optical system 52.

The 3-D image display apparatus 100 is designed such that, after the DMD 33 reflects the light which is being separated into the R, G and B components, the optical path length compensators 511b and 511c compensate for the difference in optical path length between the R, G and B components. If the color components are mixed before the optical pat length compensation, the optical path length compensators 511b and 511c cannot make the optical path length compensation. Thus, the incidence of the light being separated into the color components upon the optical path length compensators 511b and 511c requires the optical system between the DMD 33 and the optical path length compensators 511b, 511e to be both side telecentric.

Because of these circumstances, this optical system 511a is designed to be both side telecentric. According to the present invention, the processing optical system includes the optical path length compensators 511b, 511c, the dichroic mirrors 511d, 511e, the mirrors 511f, 511g, and the image rotation compensating mechanism 34.

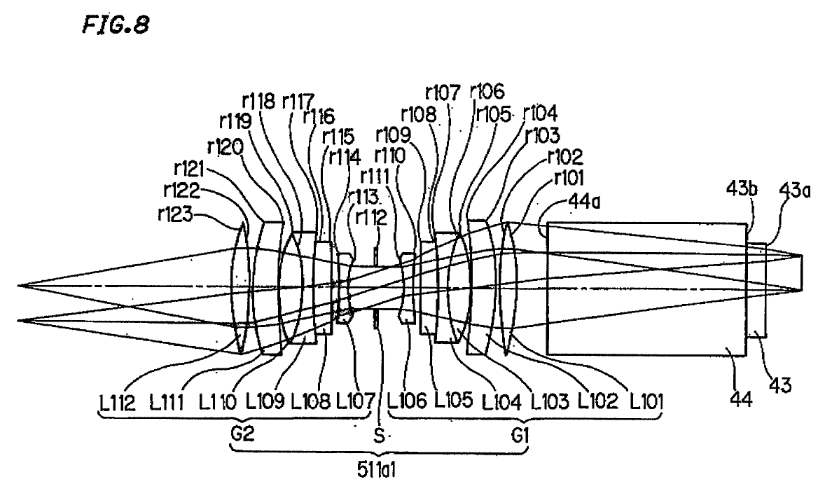

According to the present invention, the both side telecentric optical system 511a has a lens arrangement to be described below (see FIGS. 8, 10, 12, 14, 16 and 18). Specifically, the both side telecentric optical system 511 a comprises, in order from the display device (DMD 33) side: a front-group lens system (first-group lens system), a diaphragm (bundle delimiter for delimiting a luminous flux, and a rear-group lens system (second-group lens system). The front-group lens system comprises, in order from the display device (DMD 33) side: at least one front-group positive lens (first-group positive lens); a front-group cemented lens (first-group cemented lens) including at least one positive lens and at least one negative lens; and at least one front-group negative lens (first-group negative lens). The rear-group lens system comprises, in order from the display device (DMD 33) side: at least one rear-group negative lens (second-group negative lens); a rear-group cemented lens (second-group cemented lens) including at least one negative lens and at least one positive lens; and at least one rear-group positive lens (second-group positive lens). The term “positive lens” used herein means a lens element having positive optical power, and the term “negative lens” used herein means a lens element having negative optical power.

The front-group lens system and the rear-group lens system are in symmetric mirror-image relation to each other with respect to the diaphragm. This provides the both side telecentricity, and simplifies the manufacturing steps since this lens arrangement is required to manufacture the pair of lens systems similar in construction, as compared with a lens arrangement having a front-group lens system and a rear-group lens system which are different in construction from each other.

The entire both side telecentric optical system 511a in the 3-D image display apparatus capable of moving is designed to have a focal length f1 which satisfies

|f1|>75mm (1)

This is because, if the focal length f1 takes an excessively small positive or negative value, it is difficult to provide the both side telecentricity and, accordingly, a required level of performance (point spread, with an object point fixed) is not obtained.

Preferably, an intermediate portion of the 3-D image display apparatus suffers as little performance degradation (or various aberrations) as possible. In other words, it is desirable to increase the number of lenses to reduce the various aberrations. However, the provision of too many lenses results in the increased size of the entire apparatus. In view of the foregoing, each of the front-group and rear-group lens systems is designed to have two negative lenses, i.e. one more negative lens than does a typical Gaussian lens, to achieve the lens arrangement which is not so large in size and to facilitate the elimination of the aberrations. More specifically, the front-group lens system has two negative lenses, i.e. the negative lens included in the front-group cemented lens and the front-group negative lens, and the rear-group lens system has two negative lenses, i.e. the negative lens included in the rear-group cemented lens and the rear-group negative lens.

The both side telecentric optical system 511 a employs typically six positive lens but, in some cases, more positive lenses depending on the amount of correction for chromatic aberration and required performance.

The both side telecentric optical system 511a having such performance, more specifically each both side telecentric optical system 511 a1 to 511a6 in Examples to be described later, is disposed so that a focal point on the display device side is positioned at the surface of the DMD 33 and a focal point on the intermediate image side is positioned at or just before the position of incidence of light upon the above-mentioned components of the processing optical system.

As discussed hereinabove, the 3-D image display apparatus 100 according to the present invention comprises the both side telecentric optical system 511a for image-forming the light from the image displayed on the DMD 33 serving as a reflective display device. Thus, the processing optical system including the optical path length compensators 511b, 511c, the dichroic mirrors 511d, 511e, the mirrors 511f, 511g, the image rotation compensating mechanism 34, and the like for processing the light reflected from the DMD 33 may be placed on the intermediate image side of the both side telecentric optical system S la without vignetting of the light from the DMD 33 by the processing optical system. Therefore, the 3-D image display apparatus 100 can optically process an image in the processing optical system and thereafter project the image from the projection optical system 52.

The both side telecentric optical system 511a of the above lens arrangement has a long back focal length to allow the processing optical system to be easily inserted therein.

The DMD 33 is a color display device displaying the R, G and B components which are the plurality of image components constituting color. Additionally, the optical path length compensators 511b and 511c serve as an optical path length compensation optical system for compensating for the difference in optical path length between the color component images which are image-formed by the both side telecentric optical system 511a. Therefore, the both side telecentric optical system 511a can direct the light being separated into the R, G and B components into the optical path length compensators 511b and 511c. This ensures the compensation for the difference in optical path length to display a sharp 3-D image.

The both side telecentric optical system 511a having the front-group lens system and the rear group lens system which are arranged in symmetric relation with respect to the diaphragm is manufactured in simplified manufacturing steps and at low costs.

Preferred embodiments of the both side telecentric optical system 511a will be described below.

<<First Preferred Embodiment>>

The both side telecentric optical system 511a according to a first preferred embodiment particularly has an arrangement to be described below (see FIG. 8).

Each of the front-group cemented lens and the rear-group cemented lens includes one positive lens and one negative lens.

The both side telecentric optical system 511a according to the first preferred embodiment further comprises a front-group lens disposed between the front-group cemented lens and the front-group negative lens and having a refractive power weaker than a predetermined level, and a rear-group lens disposed between he rear-group cemented lens and the rear-group negative lens and having a refractive power weaker than a predetermined level.

Each of the front-group negative lens and the rear-group negative lens is disposed, with its surface of a steeper curvature oriented toward the diaphragm.

The term “lens having a refractive power weaker than a predetermined level” (referred to hereinafter as a “weak lens”) used herein means that the lens has a refractive power weaker by not greater than a predetermined ratio than does a positive lens having the strongest refractive power of all the lenses. More specifically, this means that a refractive power ratio defined by |Pw/Pm| satisfies

|Pw/Pm|<0.2 (2)

where Pm is the refractive power, in air, of the positive lens having the strongest refractive power (which is referred to hereinafter as the “strongest refractive power Pm”) and Pw is the refractive power, in air, of the lens having a weaker refractive power than the predetermined level (which is referred to hereinafter as the “weak refractive power Pw”).

As will be appreciated from Expression (2), the weak refractive power Pw may be either positive or negative since the absolute value of the refractive power ratio is calculated. In other words, the weak lens means a lens which makes fine adjustments of optical performance and such hat optical functions and effects are not significantly deteriorated by the provision of the weak lens.

Example of the both side telecentric optical system 511a having the above arrangement will be described below.

[Example 1]

FIG. 8 shows the optical path of the both side telecentric optical system 511a1 according to Example 1. In the both side telecentric optical system 511a1, a front-group lens system (first-group lens system) G1 comprises, in order from the display device side: a lens L101 having surfaces r101 and r102; a lens L102 having surfaces r103 and r104; a lens L103 having surfaces r105 and r106; a lens L104 having surfaces r106 and r107; a lens L105 having surfaces r108 and r109; and a lens L106 having surfaces r110 and r111.

A rear-group lens system (second-group lens system) G2 is provided in symmetric relation to the front-group lens system G1 with respect to a diaphragm S having a surface r112. The rear-group lens system G2 comprises, in order from the display device side: a lens L107 having surfaces r113 and r114; a lens L108 having surfaces r115 and r116; a lens L109 having surfaces r117 and r118; a lens L110 having surfaces r118 and r119; a lens L111 having surfaces r120 and r121; and a lens L112 having surfaces r122 and r123. The surfaces of the two lenses of each cemented lens which are cemented to each other are designated by the same reference character. The TIR prism 44 and the cover glass 43 are also shown in FIG. 8.

The values of respective specifications in Example 1 are listed in Table 1.

TABLE 1

| | | RADIUS | AXIAL | | |
|---|---|---|---|---|---|
| | | OF | SURFACE-TO- | | |
| LENS | SUR- | CURV- | SURFACE | | |
| (ELEMENT) | FACE | ATURE | SPACING | Nd | νd |
| | 43a | ∞ | | | |
| 43 | | | 3.00000 | 1.50847 | 61.19 |
| | 43b | ∞ | | | |
| 44 | | | 32.50000 | 1.51680 | 64.20 |
| | 44a | ∞ | | | |
| | | | 4.90599 | | |
| | r101 | 30.36044 | | | |
| L101 | | | 3.00000 | 1.71300 | 53.93 |
| | r102 | −45.36139 | | | |
| | | | 0.52004 | | |
| | r103 | 30.20090 | | | |
| L102 | | | 4.19953 | 1.71700 | 47.86 |
| | r104 | 69.14659 | | | |
| | | | 0.13737 | | |
| | r105 | 19.96057 | | | |
| L103 | | | 4.06216 | 1.71300 | 53.93 |
| | r106 | −17.12944 | | | |
| L104 | | | 1.40311 | 1.80741 | 31.59 |
| | r107 | 57.18583 | | | |
| | | | 0.13737 | | |
| | r108 | 53.85903 | | | |
| L105 | | | 2.80623 | 1.71300 | 53.85 |
| | r109 | 233.41036 | | | |
| | | | 1.31481 | | |
| | r110 | −40.22683 | | | |
| L106 | | | 1.40311 | 1.83400 | 37.05 |
| | r111 | 12.24802 | | | |
| | | | 4.65000 | | |
| | r112 | ∞ | | | |
| | | | 4.65000 | | |
| | r113 | −12.24802 | | | |
| L107 | | | 1.40311 | 1.83400 | 37.05 |
| | r114 | 40.22683 | | | |
| | | | 1.31481 | | |
| | r115 | −233.41036 | | | |
| L108 | | | 2.80623 | 1.71300 | 53.85 |
| | r116 | −53.85903 | | | |
| | | | 0.13737 | | |
| | r117 | −57.18583 | | | |
| L109 | | | 1.40311 | 1.80741 | 31.59 |
| | r118 | 17.12944 | | | |
| L110 | | | 4.06216 | 1.71300 | 53.93 |
| | r119 | −19.96057 | | | |
| | | | 0.13737 | | |
| | r120 | −69.14659 | | | |
| L111 | | | 4.19953 | 1.71700 | 47.86 |
| | r121 | −30.20090 | | | |
| | | | 0.52004 | | |
| | r122 | 45.56139 | | | |
| L112 | | | 3.00000 | 1.71300 | 53.93 |
| | r123 | −30.36044 | | | |

fl = −19692.277

In Table 1 and also in Tables 2 through 6 to be illustrated below, Nd and vd denote the refractive index and the Abbe number, respectively, for the d line (having a wavelength of 587.56 nm), and the radius of curvature and the axial surface-to-surface spacing are in millimeters. In Tables 1 through 6, “43” and “44” in the column of the lens (element) denote the cover glass 43 and the TIR prism 44, respectively. Also shown in Tables 1 through 6 are a light incident surface 43a of the cover glass 43, a light exiting surface 43b of the cover glass 43, a light incident surface 43b of the TIR prism 44 (common with the light exiting surface of the cover glass 43), and a light exiting surface 44a of the TIR prism 44.

It will be apparent from Table 1 that the focal length f1 of the entire both side telecentric optical system 511a in Example 1 satisfies Expression (1).

In the front-group lens system G1, the lens L101 corresponds to the front-group positive lens; the lenses L103 and L104 correspond to the positive and negative lenses, respectively, of the front-group cemented lens; tide lens L105 corresponds to the front-group lens; and the lens L106 corresponds to the front-group negative lens. In the rear-group lens system G2, the lens L112 corresponds to the rear-group positive lens; the lenses L109 and L110 correspond to the negative and positive lenses, respectively, of the rear-group cemented lens; the lens L108 corresponds to the rear-group lens; and the lens L107 corresponds to the rear-group negative lens.

The surface r111 having a steeper curvature (or a smaller radius of curvature) of the lens L106 serving as the front-group negative lens and the surface r113 having a steeper curvature (or a smaller radius of curvature) of the lens L107 serving as the rear-group negative lens are oriented toward the diaphragm S.

For the lens L105 serving as the weak lens, the strongest refractive power Pm and the weak refractive power Pw are calculated from Table 1.

Pm=(the radius of curvature of the surface r105 )-(the radius of curvature of the surface r106)=0.0738188

Pw=(the radius of curvature of the surface r108)-(the radius of curvature of the surface r109)=0.0102498

Therefore, the refractive power ratio for the both side telecentric optical system 511a in Example 1 satisfies the requirement of Expression (2). |Pw/Pm|=0.13885<0.2

Similarly, the surfaces r115 and r116 of the lens L108 satisfy the requirement of Expression (2) because of the symmetry of the both side telecentric optical system 511a1.

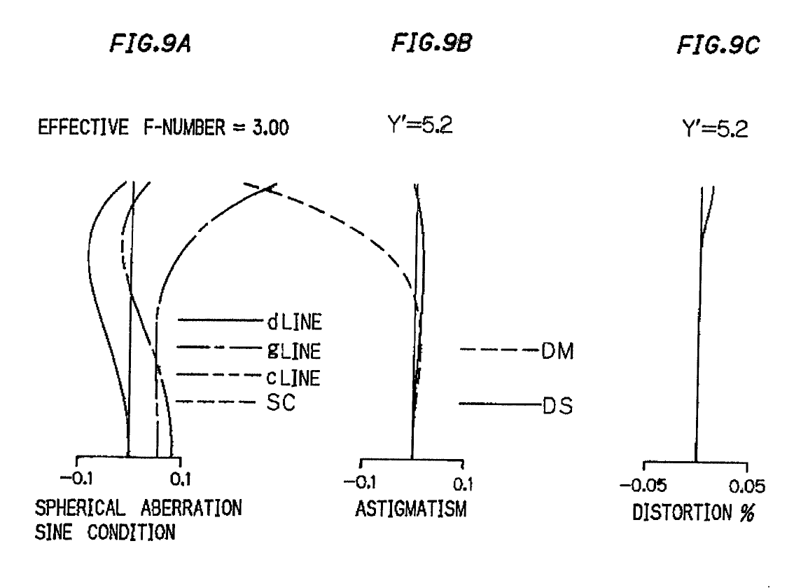

FIGS. 9A, 9B and 9C show aberrations of the both side telecentric optical system 511a according to Example 1, and illustrate optical performance on the display device side when the optical system is used at 1X magnification of a finite object disposed on the screen side. FIG. 9A shows spherical aberration, FIG. 9B shows astigmatism, and FIG. 9C shows distortion. In FIG. 9A, the vertical axis indicates an effective F-number at the above-mentioned 1X magnification; the solid curve, the dash-dot curve and the dash-double dot curve indicate spherical aberrations for the wavelengths of the d line (having a wavelength of 587.56 cm), the g line (having a wavelength of 435.84 nm) and the c line (having a wavelength of 656.28 nm), respectively; and the dotted curve indicates an amount of deviation from the sine condition. It will be found from FIG. 9A that the spherical aberration for the d line and the amount of deviation from the sine condition are substantially identical in behavior. In FIG. 9B, the vertical axis indicates an image height (mm) on the display device surface, the dotted curve (DS) indicates the position of a sagittal image surface, and the solid curve (DM) indicates the position of a meridional image surface. In FIG. 9C, the vertical axis indicates an image height (mm) on the display device surface, and the horizontal axis indicates the distortion expressed as a percentage (%). It will be appreciated from FIGS. 9A, 9B and 9C that the various aberrations are held satisfactory in Example 1.

<<Second Preferred Embodiment>>

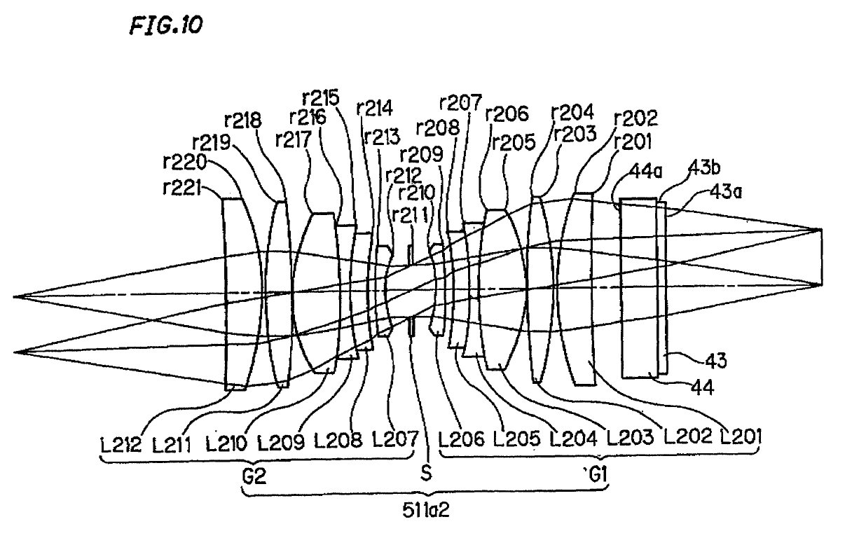

The both side telecentric optical system 511a according to a second preferred embodiment particularly has an arrangement to be described below (see FIG. 10).

The both side telecentric optical system 511a according to the second preferred embodiment comprises two front-group positive lenses and two rear-group positive lenses.

Each of the front-group cemented lens and the rear-group cemented lens includes one positive lens, one negative lens, and a lens having a refractive power weaker than a predetermined level.

Each of the front-group negative lens and the rear-group negative lens is disposed, with its surface of a steeper curvature oriented toward the diaphragm.

The term “lens having a refractive power weaker than a predetermined level” also means the above-mentioned weak lens whose refractive power ratio satisfies Expression (2). The weak refractive power Pw may be either positive or negative.

Example of the both side telecentric optical system 511a having the above arrangement will be described below.

[Example 2]

FIG. 10 shows the optical path of the both side telecentric optical system 511a2 according to Example 2. In the both side telecentric optical system 511a2, the front-group lens system (first-group lens system) G1 comprises, in order from the display device side: a lens L201 having surfaces r201 and r202; a lens L202 having surfaces r203 and r204 a lens L203 having surfaces r205 and r206; a lens L204 having surfaces r206 and r207; a lens L205 having surfaces r207 and r208; and a lens L206 having surfaces r209 and r210.

The rear-group lens system (second-group lens system) G2 is provided in symmetric relation to the front-group lens system G1 with respect to the diaphragm S having a surface r211. The rear-group lens system G2 comprises, in order from the display device side: a lens L207 having surfaces r212 and r213; a lens L208 having surfaces r214 and r215; a lens L209 having surfaces r215 and r216; a lens L210 having surfaces r216 and r217; a lens L211 having surfaces r218 and r219; and a lens L212 having surfaces r220 and r221. The surfaces of two lenses of each cemented lens which are cemented to each other are designated by the same reference character. The TIR prism 44 and the cover glass 43 are also shown in FIG. 10.

The values of respective specifications in Example 2 are listed in Table 2.

TABLE 2

| | | RADIUS | AXIAL | | |
|---|---|---|---|---|---|
| | | OF | SURFACE-TO- | | |
| LENS | SUR- | CURV- | SURFACE | | |
| (ELEMENT) | FACE | ATURE | SPACING | Nd | νd |
| | 43a | ∞ | | | |
| 43 | | | 1.40311 | 1.50847 | 61.19 |
| | 43b | ∞ | | | |
| 44 | | | 5.80000 | 1.51680 | 64.20 |
| | 44a | ∞ | | | |
| | | | 4.80000 | | |
| | r201 | −238.35743 | | | |
| L201 | | | 5.80000 | 1.71300 | 53.9 |
| | r202 | −38.25187 | | | |
| | | | 0.52004 | | |
| | r203 | 45.35655 | | | |
| L202 | | | 4.40000 | 1.71700 | 47.8 |
| | r204 | −122.88530 | | | |
| | | | 0.13737 | | |
| | r205 | 21.95340 | | | |
| L203 | | | 8.10000 | 1.71300 | 53.9 |
| | r206 | −57.79852 | | | |
| L204 | | | 1.40311 | 1.83400 | 37.0 |
| | r207 | 40.50456 | | | |
| L205 | | | 2,80623 | 1.71700 | 47.8 |
| | r208 | 48.23450 | | | |
| | | | 1.31481 | | |
| | r209 | 59.30298 | | | |
| L206 | | | 1.40311 | 1.79850 | 22.6 |
| | r210 | 13.02094 | | | |
| | | | 4.42000 | | |
| | r211 | ∞ | | | |
| | | | 4.42000 | | |
| | r212 | −13.02094 | | | |
| L207 | | | 1.40311 | 1.79850 | 22.6 |
| | r213 | −59.30298 | | | |
| | | | 1.31481 | | |
| | r214 | −48.23450 | | | |
| L208 | | | 2.80623 | 1.71700 | 47.8 |
| | r215 | −40.50456 | | | |
| L209 | | | 1.40311 | 1.83400 | 37.0 |
| | r216 | 57.79852 | | | |
| L210 | | | 8.10000 | 1.71300 | 53.9 |
| | r217 | −21.95340 | | | |
| | | | 0.13737 | | |
| | r218 | 122.88530 | | | |
| L211 | | | 4.40000 | 1.71700 | 47.8 |
| | r219 | −45.35655 | | | |
| | | | 0.52004 | | |
| | r220 | 38.25187 | | | |
| L212 | | | 5.80000 | 1.71300 | 53.9 |
| | r221 | 238.35743 | | | |

fl = 88.299

It will be apparent from Table 2 that the focal length f1 of the entire both side telecentric optical system 511a2 in Example 2 satisfies Expression (1).

In the front-group lens system G1, the lenses L201 and L202 correspond to the front-group positive lens; the lenses L203, L204 and L205 correspond to the positive, negative and weak lenses, respectively, of the front-group cemented lens; and the lens L206 corresponds to the front-group negative lens. In the rear-group lens system G2, the lenses L211 and L212 correspond to the rear-group positive lens; the lenses L210, L209 and L208 correspond to the positive, negative and weak lenses, respectively, of the rear-group cemented lens; and the lens L207 corresponds to the rear-group negative lens.

The surface r210 having a steeper curvature (or a smaller radius of curvature) of the lens L206 serving as the front-group negative lens and the surface r212 having a steeper curvature (or a smaller radius of curvature) of the lens L207 serving as the rear-group negative lens are oriented toward the diaphragm S.

For the lens L205 serving as the weak lens, the strongest refractive power Pm and the weak refractive power Pw arm calculated from Table 2.

Pm=(the radius of curvature of the surface r205)-(the radius of curvature of the surface r206)=0.0429194

Pw=(the radius of curvature of the surface r208)-(the radius of curvature of the surface r209)=0.0032669

Therefore, the refractive power ratio for the both side telecentric optical system 511a2 in Example 2 satisfies the requirement of Expression (2).

|Pw/Pm|=0.076117 <0.2

Similarly, the surfaces r214 and r215 of the lens L208 satisfy the requirement of Expression (2) because of the symmetry of the both side telecentric optical system 511a2.

FIGS. 11A, 11B and 11C show aberrations of the both side telecentric optical system 511a2 according to Example 2. FIG. 11A shows spherical aberration, FIG. 11B shows astigmatism, and FIG. 11C shows distortion The symbols illustrated in FIGS. 11A, 11B and 11C are identical with those of FIGS. 9A, 9B and 9C. It will be appreciated from FIGS. 11A, 11B and 11C that the various aberrations are held satisfactory in Example 2.

<<Third Preferred Embodiment>>

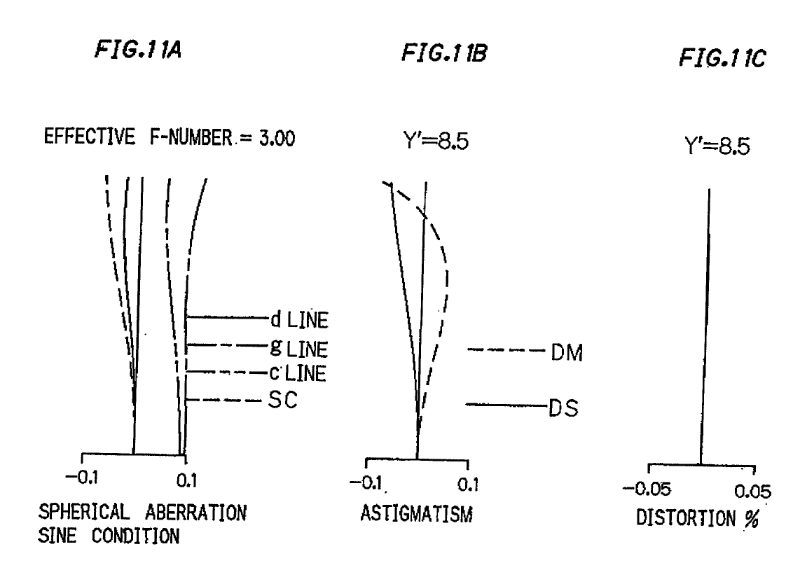

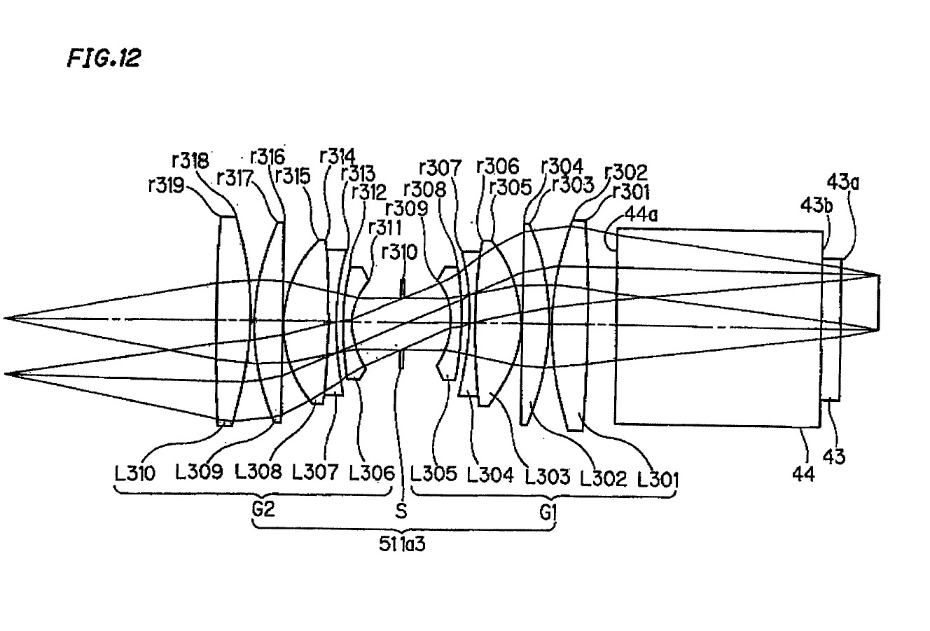

The both side telecentric optical system 511a according to a third preferred embodiment particularly has an arrangement to be described below (see FIGS. 12, 14, 16 and 18).

The both side telecentric optical system 511a according to the third preferred embodiment comprises two front-group positive lenses and two rear-group positive lenses.

Each of the front-group cemented lens and the rear-group cemented lens includes one positive lens and one negative lens.

Each of the front-group negative lens and the rear-group negative lens is disposed, with its surface of a steeper curvature oriented toward the diaphragm.

Examples of the both side telecentric optical system 511a having the above arrangement will be described below.

[Example 3]

FIG. 12 shows the optical path of the both side telecentric optical system 511a3 according to Example 3. In the both side telecentric optical system 511a3, the front-group lens system (first-group lens system) G1 comprises, in order from the display device side: a lens L301 having surfaces r301 and r302; a lens L302 having surfaces r303 and r304; a lens L303 having surfaces r305 and r306; a lens L304 having surfaces r306 and r307; and a lens L305 having surfaces r308 and r309.

The rear-group lens system (second-group lens system) G2 is provided in symmetric relation to the front-group lens system G1 with respect to the diaphragm S having a surface r310. The rear-group lens system G2 comprises, in order from the display device side: a lens L306 having surfaces r311 and r312; a lens L307 having surfaces r313 and r314; a lens L308 having surfaces r314 and r315; a lens L309 having surfaces r316 and r317; and a lens L310 having surfaces r318 and r319. The surfaces of the two lenses of each cemented lens which are cemented to each other are designated by the same reference character. The TIR prism 44 and the cover glass 43 are also shown in FIG. 12.

The values of respective specifications in Example 3 arm listed in Table 3.

TABLE 3

| | | RADIUS | AXIAL | | |
|---|---|---|---|---|---|
| | | OF | SURFACE-TO- | | |
| LENS | SUR- | CURV- | SURFACE | | |
| (ELEMENT) | FACE | ATURE | SPACING | Nd | νd |
| | 43a | ∞ | | | |
| 43 | | | 3.00000 | 1.50847 | 61.19 |
| | 43b | ∞ | | | |
| 44 | | | 32.50000 | 1.51680 | 64.20 |
| | 44a | ∞ | | | |
| | | | 4.80000 | | |
| | r301 | 283.51502 | | | |
| L301 | | | 5.60000 | 1.71300 | 53.93 |
| | r302 | −46.55025 | | | |
| | | | 0.52004 | | |
| | r303 | 32.49601 | | | |
| L302 | | | 4.80000 | 1.71700 | 47.86 |
| | r304 | 3879.27690 | | | |
| | | | 0.30000 | | |
| | r305 | 17.72740 | | | |
| L303 | | | 7.50000 | 1.72000 | 50.31 |
| | r306 | −101.32636 | | | |
| L304 | | | 1.10000 | 1.80500 | 40.97 |
| | r307 | 41.42394 | | | |
| | | | 1.31481 | | |
| | r308 | 49.81591 | | | |
| L305 | | | 1.40311 | 1.79850 | 22.60 |
| | r309 | 10.28929 | | | |
| | | | 8.15000 | | |
| | r310 | ∞ | | | |
| | | | 8.15000 | | |
| | r311 | −10.28929 | | | |
| L306 | | | 1.40311 | 1.79850 | 22.60 |
| | r312 | −49.81591 | | | |
| | | | 1.31481 | | |
| | r313 | −41.42394 | | | |
| L307 | | | 1.10000 | 1.80500 | 40.97 |
| | r314 | 101.32636 | | | |
| L308 | | | 7.50000 | 1.72000 | 50.31 |
| | r315 | −17.72740 | | | |
| | | | 0.30000 | | |
| | r316 | −3879.27690 | | | |
| L309 | | | 4.80000 | 1.71700 | 47.86 |
| | r317 | −32.49601 | | | |
| | | | 0.52004 | | |
| | r318 | 46.55025 | | | |
| L310 | | | 5.60000 | 1.71300 | 53.93 |
| | r319 | −283.51502 | | | |

fl = −35601.558

It will be apparent from Table 3 that the focal length f1 of the entire both side telecentric optical system 511a3 in Example 3 satisfies Expression (1).

In the front-group lens system G1, the lenses L301 and L302 correspond to the front-group positive lens; the lenses L303 and L304 correspond to the positive and negative lenses, respectively, of the front-group cemented lens; and the lens L305 corresponds to the front-group negative lens. In the rear-group lens system G2, the lenses L310 and L309 correspond to the rear-group positive lens; the lenses L308 and L307 correspond to the positive and negative lenses, respectively, of the rear-group cemented lens; and the lens L306 corresponds to the rear-group negative lens.

The surface r309 having a steeper curvature (or a smaller radium of curvature) of the lens L305 serving as the front-group negative lens and the surface r311 having a steeper curvature (or a smaller radius of curvature) of the lens L306 serving as the rear-group negative lens are oriented toward the diaphragm S.

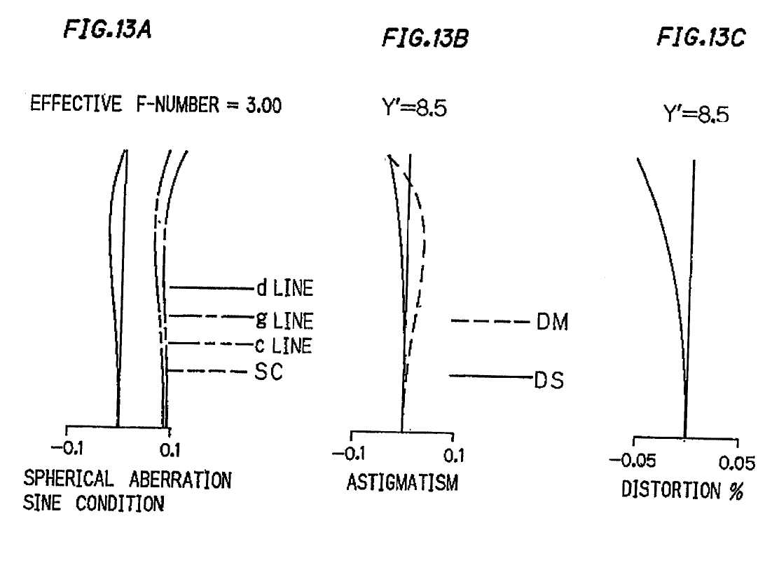

FIGS. 13A, 13B and 13C show aberrations of the both side telecentric optical system 511a3 according to Example 3. FIG. 13A shows spherical aberration, FIG. 13B shows astigmatism, and FIG. 13C shows distortion, The symbols illustrated in FIGS. 13A, 13B and 13C are identical with those of FIGS. 9A. 9B and 9C. It will be appreciated from FIGS. 13A, 13B and 13C that the various aberrations are held satisfactory in Example 3.

[Example 4]

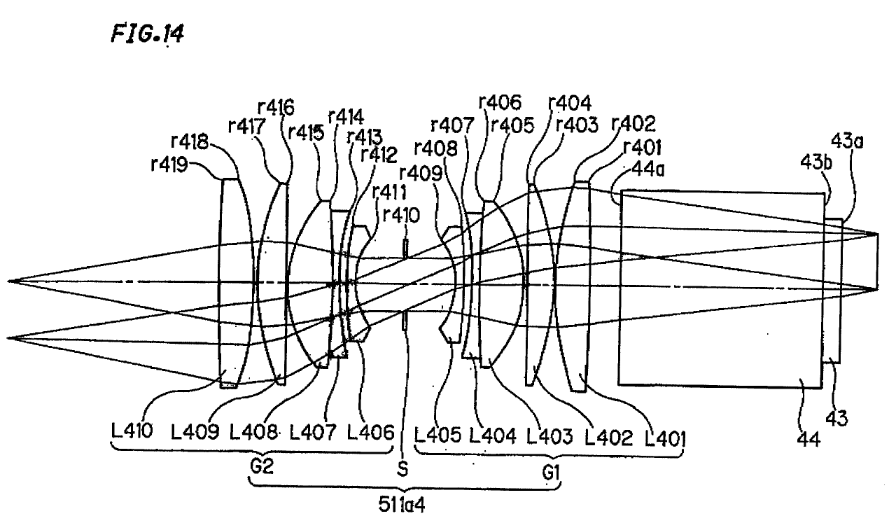

FIG. 14 shows the optical path of the both side telecentric optical system 511a4 according to Example 4. The both side telecentric optical system 511a4 is similar in lens arrangement to the both side telecentric optical system 511a3 of Example 3. More specifically, in the both side telecentric optical system 511a4, the front-group lens system (first-group lens system) GI comprises, in order from the display device side: a lens L401 having surfaces r401 and r402; a lens L402 having surfaces r403 and r404; a lens L403 having surfaces r405 and r406; a lens L404 having surfaces r406 and r407; and a lens L405 having surfaces r408 and r409.

The rear-group lens system (second-group lens system) G2 is provided in symmetric relation to the front-group lens system G1 with respect to the diaphragm S having a surface r410. The rear-group lens system G2 comprises, in order from the display device side: a lens L406 having surfaces r411 and 412; a lens L407 having surfaces r413 and r414; a lens L408 having surfaces r414 and r415; a lens L409 having surfaces r416 and r417; and a lens L410 having surfaces r418 and r419. The surfaces of the two lenses of each cemented lens which are cemented to each other are designated by the same reference character. The TIR prism 44 and the cover glass 43 are also shown in FIG. 14.

The values of respective specifications in Example 4 are listed in Table 4.

TABLE 4

| | | RADIUS | AXIAL | | |
|---|---|---|---|---|---|
| | | OF | SURFACE-TO- | | |
| LENS | SUR- | CURV- | SURFACE | | |
| (ELEMENT) | FACE | ATURE | SPACING | Nd | νd |
| | 43a | ∞ | | | |
| 43 | | | 3.00000 | 1.50847 | 61.19 |
| | 43b | ∞ | | | |
| 44 | | | 32.50000 | 1.51680 | 64.20 |
| | 44a | ∞ | | | |
| | | | 4.80000 | | |
| | r401 | 283.51502 | | | |
| L401 | | | 5.60000 | 1.71300 | 53.93 |
| | r402 | −46.81692 | | | |
| | | | 0.52004 | | |
| | r403 | 34.06350 | | | |
| L402 | | | 4.80000 | 1.71700 | 47.86 |
| | r404 | −1480.42873 | | | |
| | | | 0.30000 | | |
| | r405 | 17.46099 | | | |
| L403 | | | 7.50000 | 1.72000 | 50.31 |
| | r406 | −145.11450 | | | |
| L404 | | | 1.10000 | 1.80500 | 40.97 |
| | r407 | 41.06464 | | | |
| | | | 1.31481 | | |
| | r408 | 50.08048 | | | |
| L405 | | | 1.40311 | 1.79850 | 22.60 |
| | r409 | 10.28110 | | | |
| | | | 8.15000 | | |
| | r410 | ∞ | | | |
| | | | 8.15000 | | |
| | r411 | −10.28110 | | | |
| L406 | | | 1.40311 | 1.79850 | 22.60 |
| | r412 | −50.08048 | | | |
| | | | 1.31481 | | |
| | r413 | −41.06464 | | | |
| L407 | | | 1.10000 | 1.80500 | 40.97 |
| | r414 | 145.11450 | | | |
| L408 | | | 7.50000 | 1.72000 | 50.31 |
| | r415 | −17.46099 | | | |
| | | | 0.30000 | | |
| | r416 | 1480.42873 | | | |
| L409 | | | 4.80000 | 1.71700 | 47.86 |
| | r417 | −34.06350 | | | |
| | | | 0.52004 | | |
| | r418 | 46.81692 | | | |
| L410 | | | 5.60000 | 1.71300 | 53.93 |
| | r419 | −283.51502 | | | |

fl = 7139.838

It will be apparent from Table 4 that the focal length f1 of the entire both side telecentric optical system 511a4 in Example 4 satisfies Expression (1).

In the front-group lens system G1, the lenses L401 and L402 correspond to the front-group positive lens; the lenses L403 and L404 correspond to the positive and negative lenses respectively, of the front-group cemented lens; and the lens L405 corresponds to the front-group negative lens. In the rear-group lens system G2, the lenses L410 and L409 correspond to the rear-group positive lens; the lenses L408 and L407 correspond to the positive and negative lenses, respectively, of the rear-group cemented lens; and the lens L406 corresponds to the rear-group negative lens.

The surface r409 having a steeper curvature (or a smaller radius of curvature) of the lens L405 serving as the front-group negative lens and the surface r411 having a steeper curvature (or a smaller radius of curvature) of the lens L406 serving as the rear-group negative lens are oriented toward the diaphragm S.

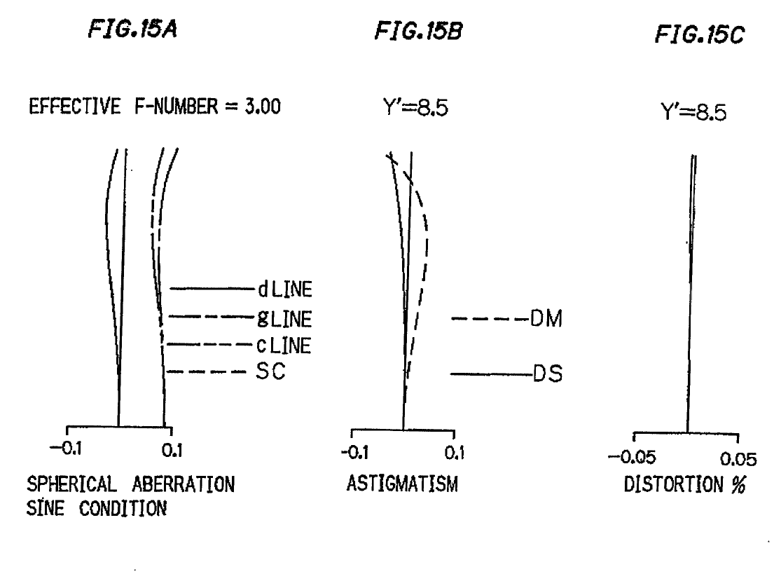

FIGS. 15A, 15B and 15C show aberrations of the both side telecentric optical system 511a4 according to Example 4. FIG. 15A shows spherical aberration, FIG. 15B shows astigmatism, and FIG. 15C shows distortion. The symbols illustrated in FIGS. 15A, 15B and 15C are identical with those of FIGS. 9A, 9B and 9C. It will be appreciated from FIGS. 15A, 15B and 15C that the various aberrations are held satisfactory in Example 4.

[Example 5]

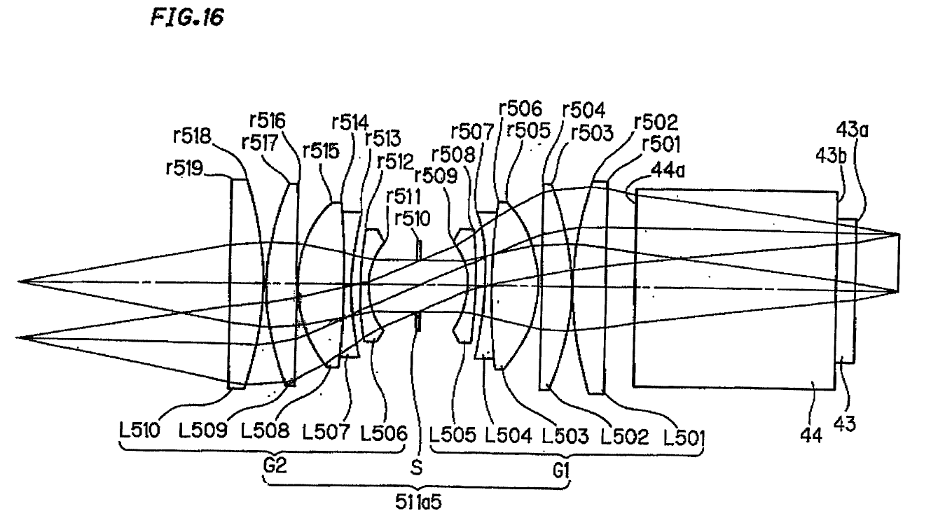

FIG. 16 shows the optical path of the both side telecentric optical system 511a5 according to Example 5. The both side telecentric optical system 511a5 is similar in lens arrangement to the both side telecentric optical system 511a3 of Example 3. More specifically, in the both side telecentric optical system 511a5, the front-group lens system (first-group lens system) G1 comprises, in order from the display device side: a lens L501 having surfaces r501 and r502; a lens L502 having surfaces r503 and r504; a lens L503 having surfaces r505 and r506; a lens L504 having surfaces r506 and r507; and a lens L505 having surfaces r508 and r509.

The rear-group lens system (second-group lens system) G2 is provided in symmetric relation to the front-group lens system G1 with respect to the diaphragm S having a surface r510. The rear-group lens system G2 comprises, in order from the display device side: a lens L506 having surfaces r511 and r512, a lens L507 having surfaces r513 and r514; a lens L508 having surfaces r514 and r515; a lens L509 having surfaces r516 and r517; and a lens L510 having surfaces r518 and r519. The surfaces of the two lenses of each cemented lens which are cemented to each other arc designated by the same reference character. The TIR prism 44 and the cover glass 43 are also shown in FIG. 16.

The values of receptive specifications in Example 5 are listed in Table 5.

TABLE 5

| | | RADIUS | AXIAL | | |
|---|---|---|---|---|---|
| | | OF | SURFACE-TO- | | |
| LENS | SUR- | CURV- | SURFACE | | |
| (ELEMENT) | FACE | ATURE | SPACING | Nd | νd |
| | 43a | ∞ | | | |
| 43 | | | 3.00000 | 1.50847 | 61.19 |
| | 43b | ∞ | | | |
| 44 | | | 32.50000 | 1.51680 | 64.20 |
| | 44a | ∞ | | | |
| | | | 4.80000 | | |
| | r501 | 4734.84848 | | | |
| L501 | | | 5.60000 | 1.69680 | 56.47 |
| | r502 | −43.21900 | | | |
| | | | 0.25000 | | |
| | r503 | 33.59400 | | | |
| L502 | | | 5.25000 | 1.71700 | 47.86 |
| | r504 | −552.92914 | | | |
| | | | 0.30000 | | |
| | r505 | 17.69700 | | | |
| L503 | | | 7.60000 | 1.71300 | 53.93 |
| | r506 | −115.32496 | | | |
| L504 | | | 1.10000 | 1.80420 | 46.50 |
| | r507 | 39.25100 | | | |
| | | | 1.50000 | | |
| | r508 | 49.27499 | | | |
| L505 | | | 1.35000 | 1.79850 | 22.60 |
| | r509 | 10.50000 | | | |
| | | | 8.18000 | | |
| | r510 | ∞ | | | |
| | | | 8.18000 | | |
| | r511 | −10.50000 | | | |
| L506 | | | 1.35000 | 1.79850 | 22.60 |
| | r512 | −49.27499 | | | |
| | | | 1.50000 | | |
| | r513 | −39.25100 | | | |
| L507 | | | 1.10000 | 1.80420 | 46.50 |
| | r514 | 115.32496 | | | |
| L508 | | | 7.60000 | 1.71300 | 53.93 |
| | r515 | −17.69700 | | | |
| | | | 0.30000 | | |
| | r516 | 552.92914 | | | |
| L509 | | | 5.25000 | 1.71700 | 47.86 |
| | r517 | −33.59400 | | | |
| | | | 0.25000 | | |
| | r518 | 43.21900 | | | |
| L510 | | | 5.60000 | 1.69680 | 56.47 |
| | r519 | −4734.84848 | | | |

fl = 309515.875

It will be apparent from Table 5 that the focal length f1 of the entire both side telecentric optical system 511b5 in Example 5 satisfies Expression (1).

In the front-group lens system G1, the lenses L501 and L502 correspond to the front-group positive lens; the lenses L503 and L504 correspond to the positive and negative lenses, respectively, of the front-group cemented lens; and the lens L505 corresponds to the front-group negative lens. In the rear-group lens system G2, the lenses L510 and L509 correspond to the rear-group positive lens; the lenses L508 and L507 correspond to the positive and negative lenses, respectively, of the rear-group cemented lens; and the lens L506 corresponds to the rear-group negative lens.

The surface r509 having a steeper curvature (or a smaller radius of curvature) of the lens L505 serving as the front-group negative lens and the surface r511 having a steeper curvature (or a smaller radius of curvature) of the lens L506 serving as the rear-group negative lens are oriented toward the diaphragm S.

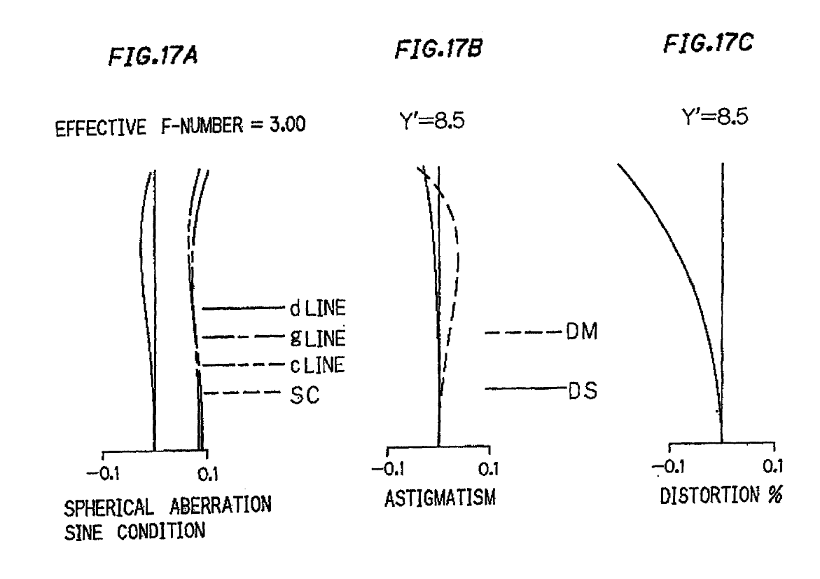

FIGS. 17A, 17B and 17C show aberrations of the both side the telecentric optical system 511a5 according to Example 5. FIG. 17A shows spherical aberration, FIG. 17B shows astigmatism, and FIG. 17C shows distortion. The symbols illustrated in FIGS. 17A, 17B and 17C are identical with those of FIGS. 9A, 9B and 9C. It will be appreciated from FIGS. 17A, 17B and 17C that the various aberrations are held satisfactory in Example 5.

[Example 6]

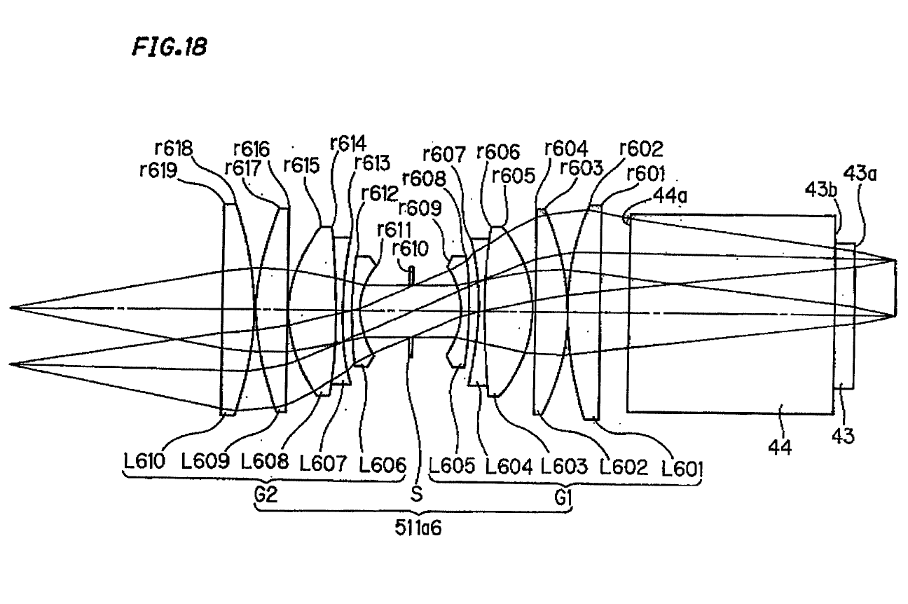

FIG. 18 shows the optical path of the both side telecentric optical system 511a6 according to Example 6. The both side telecentric optical system 511a6 is similar in lens arrangement to the both side telecentric optical system 511a3 of Example 3. More specifically, in the both side telecentric optical system 511a6, the front-group lens system (first-group lens system) G1 comprises, in order from the display device side: a lens L601 having surfaces r601 and r602; a lens L602 having surfaces r603 and r604; a lens L603 having surfaces r605 and r606; a lens L604 having surfaces r606 and r607; and a lens L605 having surfaces r608 and r609.

The rear-group lens system (second-group lens system) G2 is provided in symmetric relation to the front-group lens system G1 with respect to the diaphragm S having a surface r610. The rear-group lens system G2 comprises, in order from the display device side: a lens L606 having surfaces r611 and r612; a lens L607 having surfaces r613 and r614; a lens L608 having surfaces r614 and r615; a lens L609 having surfaces r616 and r617; and a lens L610 having surfaces r618 and r619. The surfaces of the two lenses of each cemented lens which are cemented to each other are designated by the same reference character. The TIR prism 44 and the cover glass 43 are also shown in FIG. 18.

The values of respective specifications in Example 6 are listed in Table 6.

TABLE 6

| | | RADIUS | AXIAL | | |
|---|---|---|---|---|---|
| | | OF | SURFACE-TO- | | |
| LENS | SUR- | CURV- | SURFACE | | |
| (ELEMENT) | FACE | ATURE | SPACING | Nd | νd |
| | 43a | ∞ | | | |
| 43 | | | 3.00000 | 1.50847 | 61.19 |
| | 43b | ∞ | | | |
| 44 | | | 32.50000 | 1.51680 | 64.20 |
| | 44a | ∞ | | | |
| | | | 4.80000 | | |
| | r601 | −8118.86011 | | | |
| L601 | | | 5.45000 | 1.71300 | 53.93 |
| | r602 | −41.75897 | | | |
| | | | 0.25000 | | |
| | r603 | 35.67821 | | | |
| L602 | | | 5.25000 | 1.72000 | 50.31 |
| | r604 | −1429.75608 | | | |
| | | | 0.30000 | | |
| | r605 | 18.63344 | | | |
| L603 | | | 7.90000 | 1.77250 | 49.77 |
| | r606 | −94.02172 | | | |
| L604 | | | 1.10000 | 1.83400 | 37.34 |
| | r607 | 46.22396 | | | |
| | | | 1.50000 | | |
| | r608 | 59.38253 | | | |
| L605 | | | 1.35000 | 1.84666 | 23.82 |
| | r609 | 10.98830 | | | |
| | | | 8.18000 | | |
| | r610 | ∞ | | | |
| | | | 8.18000 | | |
| | r611 | −10.98830 | | | |
| L606 | | | 1.35000 | 1.84666 | 23.82 |
| | r612 | −59.38253 | | | |
| | | | 1.50000 | | |
| | r613 | −46.22396 | | | |
| L607 | | | 1.10000 | 1.83400 | 37.34 |
| | r614 | 94.02172 | | | |
| L608 | | | 7.90000 | 1.77250 | 49.77 |
| | r615 | −18.63344 | | | |
| | | | 0.30000 | | |
| | r616 | 1429.75608 | | | |
| L609 | | | 5.25000 | 1.72000 | 50.31 |
| | r617 | −35.67821 | | | |
| | | | 0.25000 | | |
| | r618 | 41.75897 | | | |
| L610 | | | 5.45000 | 1.71300 | 53.93 |
| | r619 | 8118.86011 | | | |

fl = 68802.015

It will be apparent from Table 6 that the focal length f1 of the entire both side telecentric optical system 511a6 in Example 6 satisfies Expression (1).

In the front group lens system G1, the lenses L601 and L602 correspond to the front-group positive lens; the lenses L603 and L604 correspond to the positive and negative lenses, respectively, of the front-group cemented lens; and the lens L605 corresponds to the front-group negative lens. In the rear-group lens system G2, the lenses L610 and L609 correspond to the rear-group positive lens; the lenses L608 and L607 correspond to the positive and negative lenses, respectively, of the rear-group cemented lens; and the lens L606 corresponds to the rear-group negative lens.

The surface r609 having a steeper curvature (or a smaller radius of curvature) of the lens L605 serving as the front-group negative lens and the surface r611 having a steeper curvature (or a smaller radius of curvature) of the lens L606 serving as the rear-group negative lens are oriented toward the diaphragm S.

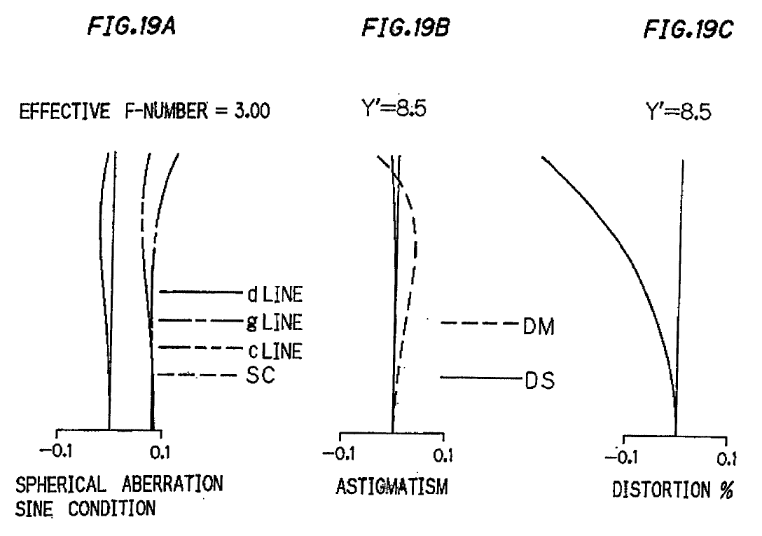

FIGS. 19A, 19B and 19C show aberrations of the both side telecentric optical system 511a6 according to Example 6. FIG. 19A shows spherical aberration, FIG. 19B shows astigmatism, and FIG. 19C shows distortion. The symbols illustrated in FIGS. 19A, 19B and 19C are identical with those of FIGS. 9A, 9B and 9C. It will be appreciated from FIGS. 19A, 19B and 19C that the various aberrations are held satisfactory in Example6.

It will be apparent from FIGS. 9A-9C, 11A-11C, 13A-13C, 15A-15C, 17A-17C and 19A-19C which show the aberrations of the both side telecentric optical systems 511a1 to 511a6 according to Examples 1 to 6 that the more the lenses, the better the aberrations.

<E. Modifications>

Although the projection apparatus and Examples of the telecentric optical system are described above, the present invention is not limited thereto.

For example, in the 3-D image display apparatus 100 described above, the image outputted from the both side telecentric optical system 511a is introduced into the processing optical system including the optical path length compensators 511b, 511c, the dichroic mirrors 511d, 511e and the mirrors 511f, 511g. However, if the optical path length compensation is not needed, the image outputted from the both side telecentric optical system 511a may be directly induced into other processing optical systems such as the image rotation compensating mechanism 34. Further, a projector which simply displays a 2-D image on an enlarged scale may be designed so that the image outputted from the telecentric optical system is directly introduced into the projection optical system.

The front-group lens system G1 and the rear-group lens system G2 are in symmetric relation to each other with respect to the diaphragm S in the both side telecentric optical system 511a of all types illustrated in Examples 1 through 6, but may be in asymmetric relation, with any one of the lenses slightly shifted.

While the lens units constituting the above described embodiments include only refractive type lens elements that deflects the incident light by refraction (that is, lens elements of a type in which the incident light is deflected at the interface between media having different refractive indices), the present invention is not limited thereto. For example, the lens units may include a diffractive type lens element that deflects the incident light by diffraction, a refraction-diffraction hybrid lens element that deflects the incident light by combination of diffraction and refraction, a gradient index lens element that deflects the incident light by the distribution of refractive index in the medium, and the like.

While the invention has been described in detail, the foregoing description is in all aspects illustrative and not restrictive. It is understood that numerous other modifications and variations can be devised without departing from the scope of the invention.

What is claimed is:

1. A projection apparatus comprising:
a display device for displaying an image to be projected;
a both side telecentric optical system for image-forming said image displayed on said display device as an intermediate image on an intermediate image plane; and
a projection optical system for projecting said intermediate image formed on said intermediate image plane onto a final image plane.

2. The projection apparatus according to claim 1, wherein said both side telecentric optical system has a magnification of 1X.

3. The projection apparatus according to claim 1, wherein said both side telecentric optical system comprises, in order from a side of said display device:
a first-group lens system;
a diaphragm; and
a second-group lens system; and
wherein said first-group lens system and said second-group lens system are in symmetric mirror-image relation to each other with respect to said diaphragm.

4. The projection apparatus according to claim 3, wherein said first-group lens system comprises, in order from the side of said display device: at least one first-group positive lens element; a first-group cemented lens including at least one positive lens element and at least one negative lens element; and at least one first-group negative lens element, and
said second-group lens system comprises, in order from the side of said display device: at least one second-group negative lens element; a second-group cemented lens including at least one negative lens element and at least one positive lens element; and at least one second-group positive lens element.

5. The projection apparatus according to claim 4, wherein
said at least one positive lens element and said at least one negative lens element in each of said first-group cemented lens and said second-group cemented lens are a single positive lens element and a single negative lens element, respectively;
said first-group lens system further comprises a first-group lens element between said first-group cemented lens and said first-group negative lens clement;
said second-group lens system further comprises a second-group lens element between said second-group cemented lens and said second-group negative lens element; and
each of said first-group negative lens element and said second-group negative lens element is disposed, with its surface of a steeper curvature oriented toward said diaphragm.

6. The projection apparatus according to claim 4, wherein said at least one first-group positive lens element includes two first-group positive lens elements;
said at least one positive lens element and said at least one negative lens element in said first-group cemented lens are a single positive lens element and a single negative lens element, respectively;
said first-group cemented lens further comprises another lens element;
said at least one first-group negative lens element is disposed, with its surface of a steeper curvature oriented toward said diaphragm;
said at least one second-group positive lens element includes two second-group positive lens elements;
said at least one positive lens element and said at least one negative lens element in said second-group cemented lens are a single positive lens element and a single negative lens element, respectively;
said second-group cemented lens further comprises another lens element; and
said at least one second-group negative lens element is disposed, with its surface of a steeper curvature oriented toward said diaphragm.

7. The projection apparatus according to claim 4, wherein
said at least one first-group positive lens element includes two first-group positive lens elements;
said at least one positive lens clement and said at least one negative lens element in said first-group cemented lens are a single positive lens element and a single negative lens element, respectively;
said at least one first-group negative lens element is disposed, with its surface of a steeper curvature oriented toward said diaphragm;
said at least one second-group positive lens element includes two second-group positive lens elements;
said at least one positive lens element and said at least one negative lens element in said second-group cemented lens are a single positive lens element and a single negative lens element, respectively; and
said at least one second-group negative lens element is disposed, with its surface of a steeper curvature oriented toward said diaphragm.

8. The projection apparatus according to claim 1, wherein
said display device is a reflective device.

9. The projection apparatus according to claim 8, wherein
said reflective device is a digital micromirror device.

10. The projection apparatus according to claim 1, further comprising
an illumination optical system for introducing illuminating light for illuminating said display device onto said display device.

11. The projection apparatus according to claim 10, wherein
said illumination optical system comprises a TIR (total internal reflection) prism.

12. The projection apparatus according to claim 11, wherein
said TIR prism is disposed between said display device and said both side telecentric optical system.

13. The projection apparatus according to claim 1, further comprising
an image rotation compensating mechanism disposed between said both side telecentric optical system and said intermediate image plane for compensating for rotation of said intermediate image to be formed on said intermediate image plane.

14. A three-dimensional image display apparatus comprising:
a screen driven to rotate about an axis of rotation included in a projection surface thereof; and
a projection apparatus for projecting an image onto said screen, said projection apparatus comprising:
a display device for displaying said image;
a both side telecentric optical system for image-forming said image displayed on said display device as an intermediate image on an intermediate image plane; and
a projection optical system for projecting said intermediate image formed on said intermediate image plane onto a final image plane.

15. The three-dimensional image display apparatus according to claim 14, wherein
said both side telecentric optical system has a magnification of 1X.

16. The three-dimensional image display apparatus according to claim 14, wherein
said both side telecentric optical system comprises, in order from a side of said display device:
a first-group lens system;
a diaphragm; and
a second-group lens system; and
wherein said first-group lens system and said second-group lens system are in symmetric mirror-image relation to each other with respect to said diaphragm.

17. The three-dimensional image display apparatus according to claim 14, wherein
said display device is a reflective device.

18. The three-dimensional image display apparatus according to claim 17, wherein
said reflective device is a digital micromirror device.

19. The three-dimensional image display apparatus according to claim 14, further comprising
an illumination optical system for introducing illuminating light for illuminating said display device onto said display device.

20. The three-dimensional image display apparatus according to claim 19, wherein
said illumination optical system comprises a TIR (total internal reflection) prism.

21. The three-dimensional image display apparatus according to claim 20, wherein
said TIR prism is disposed between said display device and said both side telecentric optical system.

22. The three-dimensional image display apparatus according to claim 14, further comprising
an image rotation compensating mechanism disposed between said both side telecentric optical system and said intermediate image plane for compensating for rotation of said intermediate image to be formed on said intermediate image plane.
